(19) United States
(12) Patent Application Publication
(10) Pub. No.: US 2011/0321070 A1
(43) Pub. Date: Dec. 29, 2011

(54) METHOD AND APPARATUS OF REMOTE VIDEO DISTRIBUTION

(75) Inventor: Hoi Ming Robert Chan, Sheung Wan (HK)

(73) Assignee: e-Video Rental System Limited, Sheung Wan (HK)

(21) Appl. No.: 12/822,576

(22) Filed: Jun. 24, 2010

(51) Int. Cl. H04N 7/16; H04N 7/167; H04N 7/173

(52) U.S. Cl. 725/5; 725/86; 725/31; 725/29

(57) ABSTRACT

A method of remote video file distribution, the method comprising the steps of: a user browsing information relating to video titles on a user terminal device; the user selecting a video title and sending an order of the selection of the video title from the personal terminal device via a telecommunications network to a remote order processing apparatus; the order processing apparatus sending an order confirmation package, including order identification information, to the user; the order processing apparatus sending information relating to the order and the order identification information to an order pick-up terminal; and the order pick-up terminal delivering a video file of video content to the user upon presentation of the order identification information.

### FIELD OF THE INVENTION

The present invention relates to remote video file distribution, and more particularly, to remote video distribution of video files with security means to prevent unauthorized re-distribution. More specifically, although not solely limited thereto, this invention relates to distribution of high definition video or movies via the internet.

### BACKGROUND OF THE INVENTION

Video rentals provide an economical alternative for consumers to enjoy video recordings such as movies or television series without having to pay for the full price of a licensed copy. The conventional mode of video recording rentals typically includes a video rental shop which is provided with an area for displaying miniaturized poster copies of video recordings. An intended video renter will need to go to the shop and select video recording titles of interest and pay at a counter. The consumer will then get hard copies of the video recordings for a certain number of days after payment.

The conventional mode of video rental business, as depicted in FIG. 1, means that a video rental service provider, or a video rental shop in short, must stock a large number of video discs and provide a large shop area for consumer browsing and selection. The shop area, the costs of getting hard copies, as well as costs for managing a large volume of disc inventories and managing in and out of discs all add to the costs of a video rental shop, thereby making the costs of operating video rental shops more inhibitive.

On the other hand, consumers must travel to the rental shops to browse, select and bring discs copies home. They then need to return to the shop after use. All these mean inconvenience to consumers as well as adding costs to renting video discs.

While the video rental market provides an important source of revenue for owners of the video titles, the convention mode of video rental business, in which hard copies of video contents in disc forms are distributed, is not entirely for their interest because this mode facilitates copying and unauthorized re-distribution easier.

Therefore, it will be advantageous if a new system and/or arrangement which will alleviate at least some or all of the above shortcomings could be provided.

### SUMMARY OF THE INVENTION

According to the present invention, there is provided a method of remote video file distribution, the method comprising the steps of:
a user browsing information relating to video titles on a user terminal device;
the user selecting a video title and sending an order of the selection of the video title from the personal terminal device via a telecommunications network to a remote order processing apparatus;
the order processing apparatus sending an order confirmation package, including order identification information, to the user;
the order processing apparatus sending information relating to the order and the order identification information to an order pick-up terminal; and
the order pick-up terminal delivering a video file of video content to the user upon presentation of the order identification information.

This method facilitates distribution of high quality video files via the internet in security and with user convenience.

The method may further comprise the step of the user paying a pre-agreed fee at the order pick-up terminal before the video file is delivered to the user.

The payment may be effectuated by electronic means, such as by inductive payment means including an electronic card or purse, the electronic card or purse being charged with a pre-stored cash value which are deductible by the pick-up terminal by inductively coupling.

The telecommunications network may be a mobile telephone or mobile data network or the internet.

The video file may be delivered in security encryption to prevent unauthorized viewing.

The method may further comprise the step of the user inserting a writable medium for downloading the video file.

The method may further comprise the steps of:
The order pick-up terminal storing a proof of purchase in the writable medium, and
A user using the proof of purchase as an authentication of purchase.

The method may further comprise the steps of:
sending the proof of purchase from a user terminal device to the remote order processing apparatus for authentication, and
the remote order processing apparatus sending a permission-to-view to the user terminal device.

The method may further comprise activating a timer when a user begins to view the video file, the timer being arranged to render the video file un-viewable after a prescribed time.

The video file may be formatted for high definition video viewing, such as 1024 lines×pixels per frame. The method therefore provides a convenient way of distributing high quality video files, such video files would otherwise have taken hours to download by home computers via the internet.

The method may further comprise a step of playing the video file from the encrypted video file and starting a timer when the video file is played, the timer being preset to prevent playing of the video file after a preset time.

The order pick-up terminal may be installed in publicly accessible kiosk. Such a kiosk provides convenient public accessibility as well as shared resources for the general user.

The method may further comprise the step of requesting the user to select a pick-up terminal among a plurality of available terminals. Such an arrangement provides added convenience and flexibility to the user or consumer.

According to another aspect of the present invention, there is provided an apparatus for remote video distribution, the apparatus comprising a personal terminal device, a remote order processing apparatus and an order pick-up terminal, wherein:
the personal terminal device is arranged to permit a user to browse information relating to video titles on, to select a video title, and then to send an order of the selection of the video title from the personal terminal device via a telecommunications network to a remote order processing apparatus;
the order processing apparatus is arranged to send an order confirmation package, including order identification information, to the user; the order processing apparatus is further arranged to send information relating to the order and the order identification information to an order pick-up terminal; and
the order pick-up terminal is arranged to deliver a video file of video content to the user upon presentation of the order identification information.

The apparatus may further comprise a video player, the video comprising a decryption device for decrypting the video file for view and a timer which is arranged to be actuated when the video file is played, the timer setting a preset time at the expiry of which the video file is no longer viewable. Such an arrangement provides security to the owner of the video file to mitigate the risk of unauthorized dissemination or use of the video files.

### BRIEF DESCRIPTION OF HE FIGURES

Preferred embodiments of the present invention will be explained by way of example and with reference to the accompanying Figures, in which:

FIG. 1 is a schematic diagram depicting a convention or prior art model of video rental arrangement,

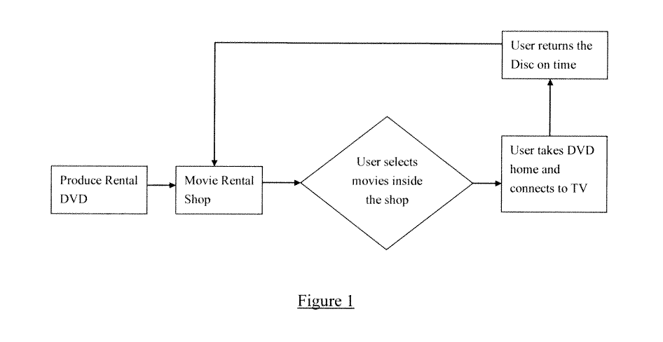

FIG. 2 is a schematic diagram depicting an exemplary embodiment of a video rental arrangement of a video selection and distribution arrangement according to the present invention,

FIG. 2A is a schematic flow illustrating an exemplary a video distribution process by a content provider at a Remote Terminal according to an embodiment of the present invention,

FIG. 3 is an exemplary user interface webpage at an exemplary Remote Terminal,

FIG. 4 is a sub-page of the web-page of FIG. 3 showing a drop-down menu of movie categories,

FIG. 5 is a sub-page of the web-page of FIG. 4 showing more details of a title,

FIGS. 6 & 6A are flowcharts showing an exemplary video file collection process at a kiosk or shop,

FIG. 6B is an exemplary screen at a kiosk showing a prompt by a kiosk to a user to connect an e-disc to the kiosk,

FIG. 7 is an exemplary screen at a kiosk showing a downloading portion of the selected titles downloading process,

FIG. 8 is an exemplary screen at a kiosk prompting a user completion of the selected titles downloading process,

FIG. 9 is a diagram illustrating an exemplary flow of process in which voucher delivery between a kiosk, a service gateway and a billing gateway is shown,

FIG. 9A illustrates an exemplary flow of process at a user terminal

FIG. 10 is a perspective view of an exemplary e-disc,

FIGS. 11 and 11A shows an e-disc and an e-disc adaptor respectively in separation and connection.

### DETAILED DESCRIPTION OF EXEMPLARY EMBODIMENTS

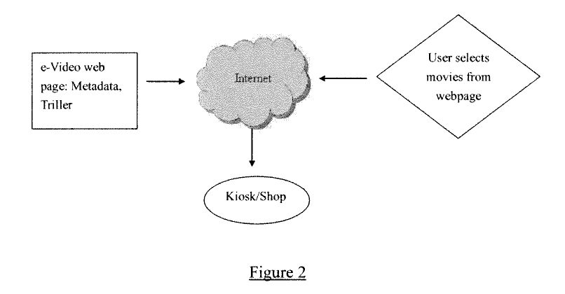

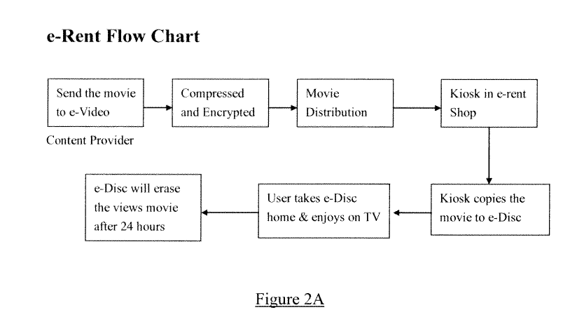

FIG. 2 shows a schematic arrangement of an exemplary video selection and distribution system illustrating an embodiment of the present invention. The exemplary arrangement comprises a plurality of user terminals as example of user terminal devices, a remote video distribution terminal as example of a remote order processing apparatus, a plurality of local pick-up terminals and telecommunication links. The telecommunication links provide connection between the user terminals and the remote video distribution terminal, and between the remote video distribution terminal (the “Remote Terminal”) and the video pick-up terminals to be explained below.

A home computer installed with an Internet browser and connectible to a remote video distribution terminal via the Internet is used as an example of a user terminal in this example. After data connection between the home computer and the Remote Terminal has been made, a user could then access the webpage (as an example of a user interface) of the Remote Terminal. The webpage provides a gateway for remote users so that the users around the world could access a database of video titles available at the Remote Terminal by means of webpage access via the home computer.

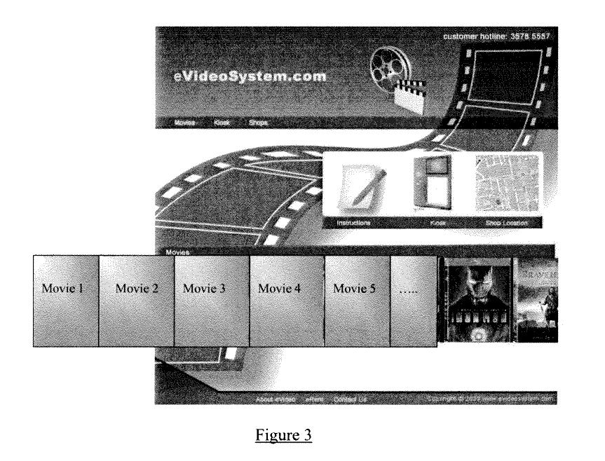

In the exemplary webpage of FIG. 3, a tab with heading movies on an upper title bar is provided. This tab provides a gateway for user selection of movies. The movies available at the tab could be arranged by alphabetic order, by movie types and/or categories, by alphabetical order of directors, script writers or actors, or by any appropriate order. In addition, a plurality of most commonly selected (or top hits) also appears at the bottom of the webpage for more expeditious selection of hit titles.

In addition to providing textual and pictorial information (such as miniaturized posters) on video titles available for consumer selection on a lower portion of the webpage, the webpage also includes an upper row of tabs identified by the exemplary identification “Movies”. Each of the kiosk or shop tab is associated respectively with a list of physical kiosks or shops to facilitate user selection of a physical location for collecting a copy of a selected video file to be described in more detail below.

Each of the kiosk and shop tab in the upper row is associated with a row of labels which appears intermediate the upper and lower rows when associated. The intermediate row consists of the string of labels “instructions”, “kiosk” and “kiosk location” when associated with “kiosk”, and “instructions”, “shop” and “shop location” when associated with the selection of “shops” in the upper row. In other words, the kiosk label in the lower row will be replaced by a “shop” label if the tab “shops” in the upper row is selected. The image of a specific shop or kiosk together with a neighborhood map for guiding a user to collect a video file in a manner to be detailed below is displayed adjacent the labels kiosk/shop and kiosk/shop location where selected.

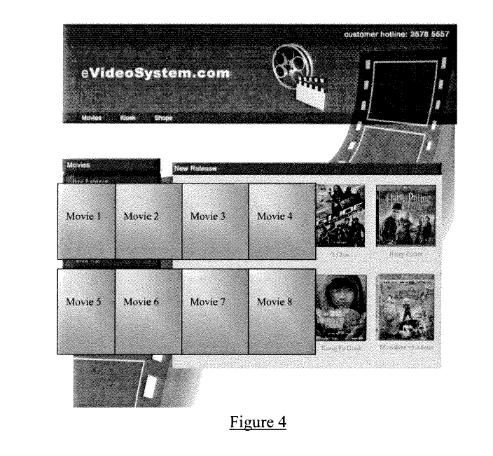

When the movie tab is selected, a drop-down menu comprising movie categories set out in a list for user selection will be displayed as in FIG. 4. The categories of “New Release”, “Comedy”, “Documentary”, “Horror”, “TV Drama”, “Chinese”, “Blue Ray”, and “Children” are included in the present exemplary webpage layout as an exemplary illustration. Each category in the list is associated with a list of movie titles together with a miniaturized poster above each title in tabulated form for user browsing and selection.

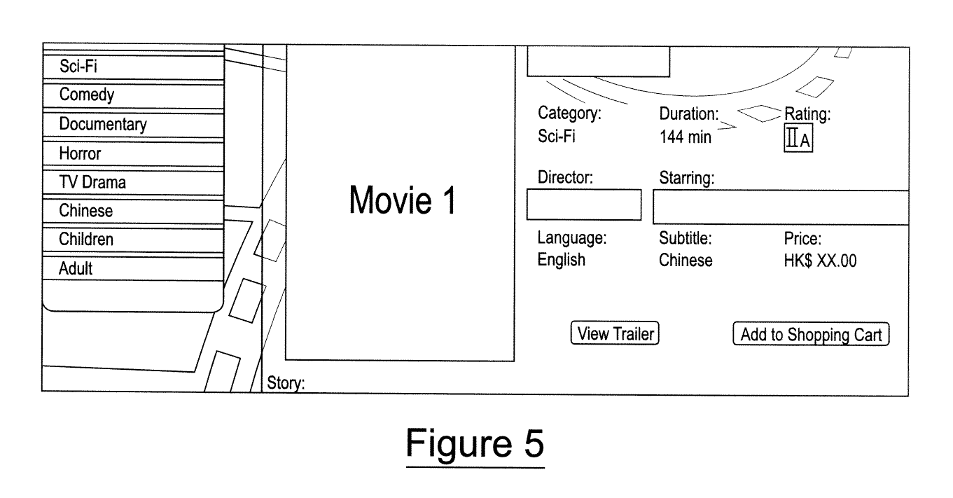

Additional information on a selected movie title will be displayed when a user clicks on a particular movie title, as depicted in the exemplary layout display of FIG. 5. The additional information may include, for example, category, duration, rating, director, casting, language, subtitle, and price, relating to the video product to be rented. A trailer preview tab is also provided to enable user preview before selection and an “add to Shopping Cart” tab is provided to enable a user to rent a copy.

After a movie or a number of movies have been selected and placed in the electronic shopping cart, the user will be guided to select a physical location of a shop or a kiosk for picking up the order. A location map also appears on the screen to assist a user to get to the kiosk or shop. After the selection process has been completed, an order identification code will be sent to the user terminal for the user to pick up an order.

In order to facilitate convenient retrieval of ordered video titles at a shop or kiosk, the present embodiment is arranged such that the order identification code is sent to an electronic storage device, nicknamed e-disc, and stored therein. An exemplary e-disc and its use will be explained in more detail below.

In order to pick up or collect the pre-ordered video recordings, a user will need to visit a pre-selected or designated kiosk or shop by a pre-determined time (say 3 days) with an e-disc which is stored with the identification code or codes. The use of a physical kiosk or shop instead of the internet for downloading video recordings is primarily due to speed consideration, since the transmission of high quality video files will take a relatively long time, for example, several hours, via the internet.

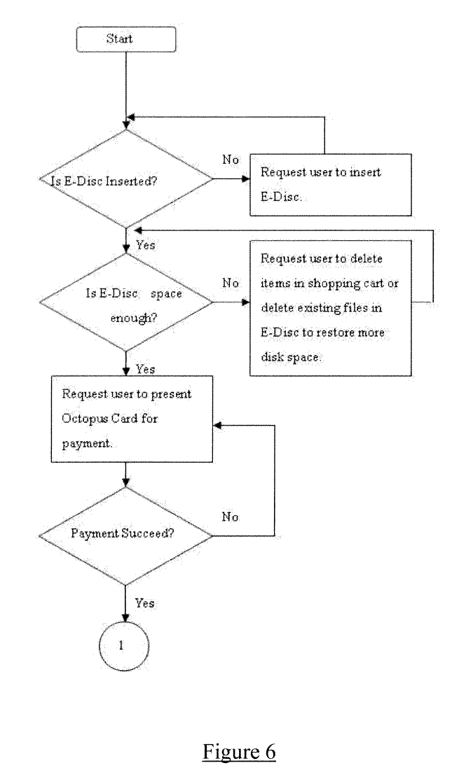

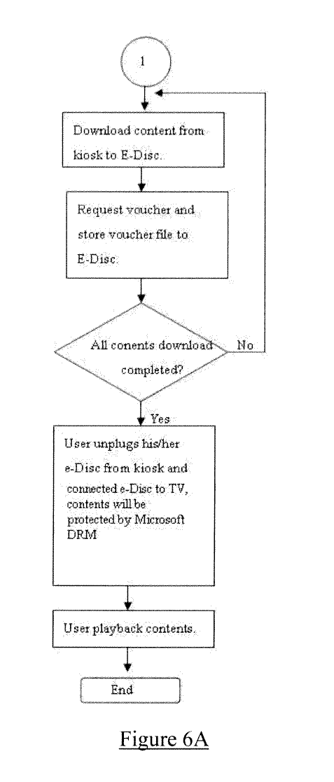

When at the kiosk or shop, a user will be prompted to present the order identification code for order retrieval. This could be done by inserting the e-disc into an e-disc receptacle slot on the kiosk. The e-disc receptacle slot comprises a connector which links up the e-disc to the processor of the kiosk when the e-disc is inserted to the kiosk. Upon detection of the e-disc, the kiosk processor will retrieve order information and begin download processing as shown in the exemplary flow charts of FIGS. 6, 6A, 6B & 7.

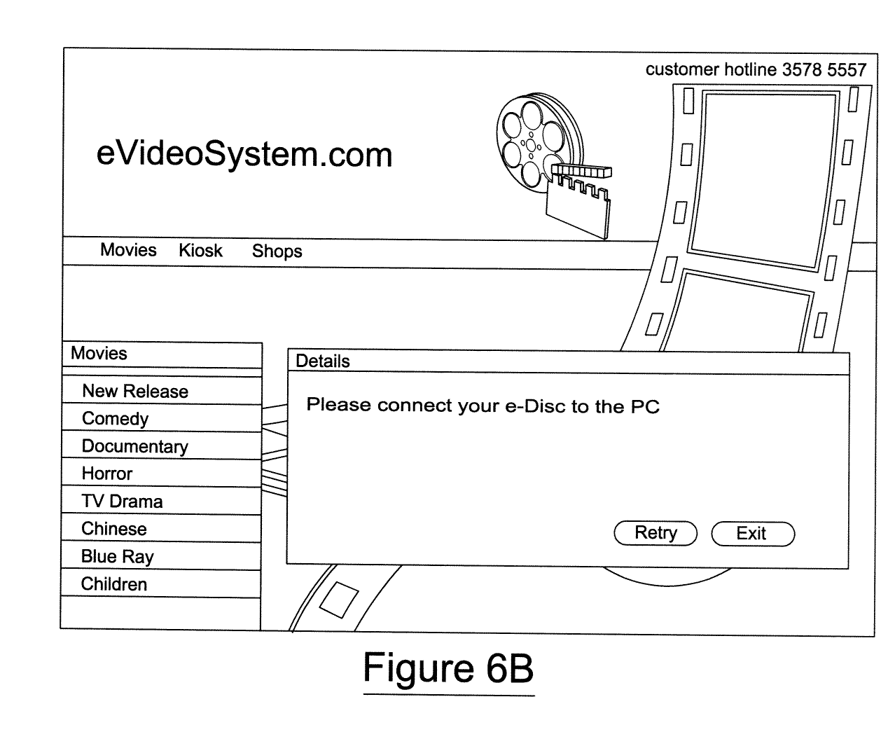

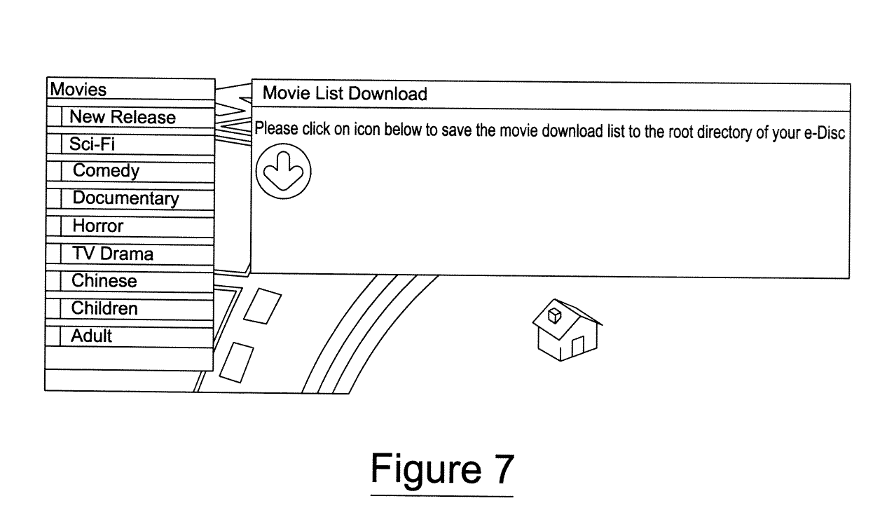

Initially, the kiosk processor will determine whether there is enough storage space on the e-disc for the specific orders as identified by the order identification code. If there is insufficient storage space, the kiosk will ask the user to either delete some of the selected titles or to delete old files on the e-disc. If the storage space is sufficient, the kiosk will ask the user to present payment, for example, by credit card or electronic money such as the type nicknamed Octopus®. After the payment transaction has been completed, the kiosk processor will proceed to the downloading procedure as described in FIG. 6A with interacting screens of FIGS. 6B and 7. The user will remove the e-disc from the connection slot after download has been completed when prompted by the kiosk as shown in FIG. 8, and take the disc for enjoyment.

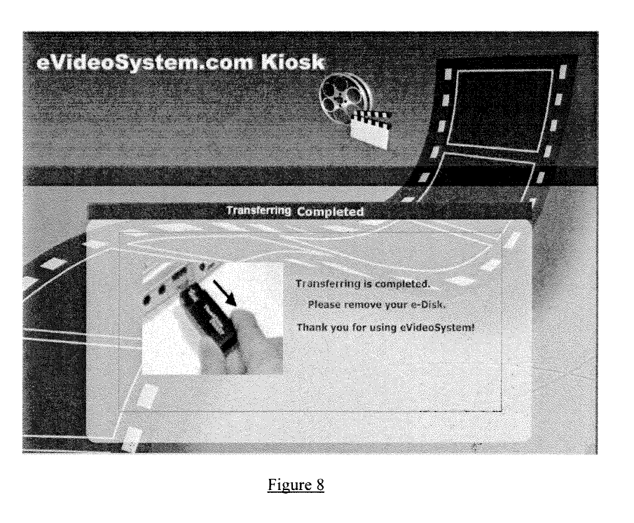

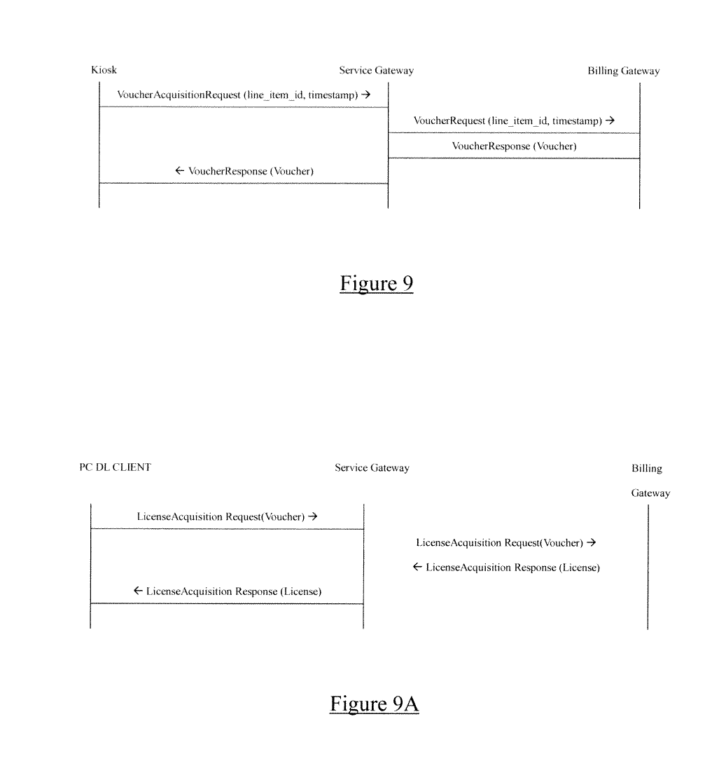

At the time of downloading a video title, the kiosk also stores a proof of purchase, nicknamed “voucher”, into the e-disc for subsequent use at a user terminal, as shown in FIG. 9. The e-disc loaded with the selected video files is then ready for user at a user terminal.

At the user terminal, a user will need to insert the e-disc into a user terminal to initiate the video viewing process. Upon insertion of the e-disc at the user terminal, the user terminal will transmit a copy of the proof of purchase, or the relevant code, to the remote terminal for authentication and to seek authorization. The remote terminal will transmit authorization to the user terminal and a user could begin viewing a selected video title with a viewing program or titles once authorization is sent to the user.

In order to safeguard the proprietary rights of the content providers, a timer is encrypted within the video content, the proof of purchase or the authorization. This time is arranged to operate to erase or destroy the video files once a pre-set or pre-determined time has expired. This will be so even if the video files have been copied.

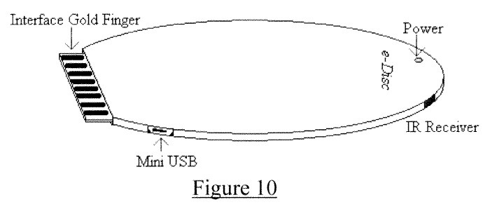

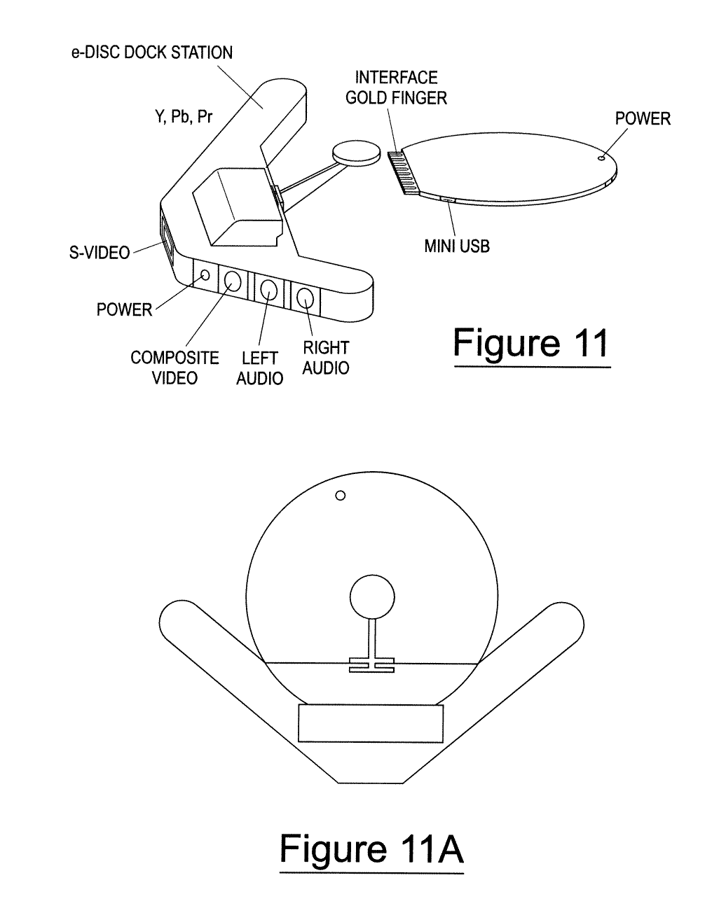

The e-disc of FIG. 10 comprises a writable storage similar to that of a memory stick but arranged into a disc form for user convenience. The e-disc includes an interfacing connector to connect the storage medium with a kiosk connector and a connector of a video viewing device at the user terminal. As shown in FIGS. 11 and 11A, an interfacing adaptor is provided to connect the e-disc to appropriate viewing apparatus.

While the present invention has been explained with reference to the exemplary embodiments, it will be appreciated that the embodiments are only for example and are not meant to restrict the scope of invention. For example, while an embodiment teaches a destruction timer encrypted within the video content, the time could be optional and/or triggered by other means, such as by way of a variable code to be sent from the remote terminal when sending a permission code to a user. Of course, other variations and modifications are possible without loss of generality.

1. A method of remote video file distribution, the method comprising the steps of:
a user browsing information relating to video titles on a user terminal device;
the user selecting a video title and sending an order of the selection of the video title from the personal terminal device via a telecommunications network to a remote order processing apparatus;
the order processing apparatus sending an order confirmation package, including order identification information, to the user;
the order processing apparatus sending information relating to the order and the order identification information to an order pick-up terminal; and
the order pick-up terminal delivering a video file of video content to the user upon presentation of the order identification information.

2. A method according to claim 1, further comprising the step of the user paying a pre-agreed fee at the order pick-up terminal before the video file is delivered to the user.

3. A method according to claim 2, wherein the payment is effectuated by electronic means, such as by inductive payment means including an electronic card or purse, the electronic card or purse being charged with a pre-stored cash value which are deductible by the pick-up terminal by inductively coupling.

4. A method according to claim 1, wherein the telecommunications network is a mobile telephone or mobile data network or the internet.

5. A method according to claim 1, wherein the video file is delivered in security encryption to prevent unauthorized viewing.

6. A method according to claim 1, further comprising the step of the user inserting a writable medium for downloading the video file.

7. A method according to claim 6, further comprising the steps of:
The order pick-up terminal storing a proof of purchase in the writable medium, and
A user using the proof of purchase as an authentication of purchase.

8. A method according to claim 7, further comprising the steps of:
sending the proof of purchase from a user terminal device to the remote order processing apparatus for authentication, and
the remote order processing apparatus sending a permission-to-view to the user terminal device.

9. A method according to claim 8, further comprising activating a timer when a user begins to view the video file, the timer being arranged to render the video file un-viewable after a prescribed time.

10. A method according to claim 1, wherein the video file is formatted for high definition video viewing, such as 1024 lines×pixels per frame.

11. A method according to claim 1, further comprising a step of playing the video file from the encrypted video file and starting a timer when the video file is played, the timer being preset to prevent playing of the video file after a preset time.

12. A method according to claim 1, wherein the order pick-up terminal is installed in publicly accessible kiosk.

13. A method according to claim 1, further comprising the step of requesting the user to select a pick-up terminal among a plurality of available terminals.

14. An apparatus for remote video distribution, the apparatus comprising a personal terminal device, a remote order processing apparatus and an order pick-up terminal, wherein
the personal terminal device is arranged to permit a user to browse information relating to video titles on, to select a video title, and then to send an order of the selection of the video title from the personal terminal device via a telecommunications network to a remote order processing apparatus;
the order processing apparatus is arranged to send an order confirmation package, including order identification information, to the user; the order processing apparatus is further arranged to send information relating to the order and the order identification information to an order pick-up terminal; and
the order pick-up terminal is arranged to deliver a video file of video content to the user upon presentation of the order identification information.

15. An apparatus according to claim 14, further comprising a video player, the video player comprising a decryption device for decrypting the video file for view and a timer which is arranged to be actuated when the video file is played, the timer setting a preset time at the expiry of which the video file is no longer viewable.
